(19) United States
(12) Patent Application Publication
(10) Pub. No.: US 2010/0130646 A1
(43) Pub. Date: May 27, 2010

(54) METHOD FOR MANUFACTURING EPOXY NANOCOMPOSITE MATERIAL CONTAINING VAPOR-GROWN CARBON NANOFIBERS AND ITS PRODUCTS THEREBY

(75) Inventors: Soo-Jin Park, Daejun (KR); Jae-Rock Lee, Daejun (KR); Eun-Jung Lee, Gyeonggi-do (KR); Min Kang Seo, Daejun (KR)

Correspondence Address: REINHART BOERNER VAN DEUREN P.C., 2215 PERRYGREEN WAY, ROCKFORD, IL, 61107, US

(73) Assignee: KOREA RESEARCH INSTITUTE OF CHEMICAL TECHNOLOGY, Daejun (KR)

(21) Appl. No.: 12/446,424

(22) PCT Filed: Oct. 31, 2006
(86) PCT No.: PCT/KR06/04492

§ 371 Date: Apr. 20, 2009

(51) Int. Cl. C08L 63/00

(52) U.S. Cl. 523/440; 523/468; 977/840; 977/778

(57) ABSTRACT

Disclosed is a method for producing an epoxy nanocomposite material containing vapor-grown carbon nanofibers and an epoxy nanocomposite material produced thereby. The method comprises physically mixing 0.1-5.0 parts by weight of vapor-grown carbon nanofibers as reinforcing materials with 100 parts by weight of an epoxy matrix resin to disperse the carbon nanofibers in the epoxy matrix resin, adding a curing agent to the mixture, and curing the mixture. According to the disclosed method, the vapor-grown carbon nanofibers are physically mixed with an epoxy matrix resin without using any solvent. Thus, the vapor-grown carbon nanofibers are sufficiently dispersed in the epoxy matrix resin compared to the case of using a solvent. Therefore, it is possible to produce an epoxy nanocomposite material having excellent mechanical strength and low friction/wear properties at room temperature and excellent thermal properties even at high temperature. Also, the vapor-grown carbon nanofibers are cost-effective and, at the same time, used in an amount smaller than the amount of carbon nanotubes used to improve the physical properties of epoxy resin in the prior art, thus effectively reducing the production cost of the nanocomposite material.

### TECHNICAL FIELD

The present invention relates to a method for manufacturing an epoxy nanoparticle material containing vapor-grown carbon nanofibers, and a nanocomposite material produced thereby. More particularly, the present invention relates to an epoxy nanocomposite material containing vapor-grown carbon nanofibers, which is produced by physically mixing vapor-grown carbon nanofibers with an epoxy matrix resin without using any solvent and then curing the mixture in optimal conditions, and thus has excellent mechanical strength and low frictional/wear properties at room temperature, and excellent thermal properties even at high temperature.

### BACKGROUND ART

With the development of the modern industrial society, the development of novel materials having excellent physical properties compared to those of prior materials has been required in various field. Also, with the recent development of nanotechnology, many studies on nanocomposite materials have been conducted. Among the nanocomposite materials, epoxy resin, which is one of thermosetting polymers, is excellent in electrical properties, adhesion, tensile strength, elastic modulus, thermal resistance and chemical resistance, and thus is widely used in various applications, including high-performance materials, coating materials, housing coating materials, PCB plates, artificial joints, microparts for medical and engineering applications, spacecraft and aircraft parts, semiconductor-encapsulating materials, cell-insulating materials, adhesives, matrixes for composite materials, and coating compounds.

However, such epoxy resin has a shortcoming in that it is readily brittle even upon the application of low impact because of low mechanical properties, high thermal expansion coefficients and high crosslinking densities. For this reason, to improve the thermal and mechanical properties of the epoxy resin, many studies on blends containing reinforcing materials have been conducted. For example, International Patent Publication No. WO2005-28174 and US Patent Publication No. 2003-3270 disclose methods of producing composite materials by adding either various reinforcing materials or reinforcing materials containing functional group to the thermosetting epoxy resin in order to improve the thermal properties and mechanical properties of the epoxy resin.

It is generally known that reinforcing materials for use in the production of nanocomposite materials are layered nanomaterials such as silica and clay, which have a very high aspect ratio. It is known that if these materials are uniformly dispersed in a polymer matrix, various properties including mechanical properties, thermal properties, gas permeability and flame-retardant properties of the polymer can be greatly improved. However, such nanocomposite materials filled with layered inorganic compounds lack physical properties such as electric conductivity, and optical and dielectric properties. For this reason, many studies on nanocomposites containing carbon black and metal powder as fillers have been conducted. However, said carbon black or metal powder should be added to the polymer matrix in large amounts in order to exhibit sufficient conductivity, thus causing another problem of reducing the mechanical properties of the resulting polymer composite materials. For this reason, in an attempt to increase mechanical properties, there is known a carbon nanotube-reinforced thermosetting matrix resin nanocomposite having improved toughness, by dissolving carbon nanotubes in ethanol, sufficiently dispersing the carbon nanotubes and the ethanol in a polymer epoxy resin with ultrasonic waves, and then curing the mixture in a mold [Y. S. Song and J. R. You., Carbon, 2005, 43, 1378].

Also, vapor-grown carbon nanofibers have been recently proposed, which has a high aspect ratio and are chemically very stable, because they have a structure in which graphite phases are arranged in the form of an annual ring with respect to fibers. Particularly, although the vapor-grown carbon nanofibers also serve as reinforcing materials, they have excellent thermal stability due to the graphite components and are also applicable in the friction and abrasion fields. Thus, they are expected to have excellent properties compared to other materials, including metals, due to specific strength, specific rigidity, thermal expansion, corrosion resistance and the like, when they are used as materials for reinforcing polymers.

Leading to the present invention, intensive and thorough to solve the problems occurring in the prior art and to provide a nanocomposite material having improved physical properties using epoxy resin and, as a result, found that an epoxy nanocomposite material having excellent impact strength and low thermal expansion coefficient and wear loss properties, could be produced by physically mixing vapor-grown carbon nanofibers with an epoxy matrix resin to achieve complete mixing of the carbon nanofibers with the epoxy matrix resin, compared to the case of using a solvent, and then curing the mixture in optimal conditions.

### DISCLOSURE

### Technical Problem

Accordingly, it is an object of the present invention to provide a method for manufacturing an epoxy nanocomposite material containing vapor-grown carbon nanofibers.

It is another object of the present invention to provide an epoxy nanocomposite material containing vapor-grown carbon nanofibers, produced using said production method.

### Technical Solution

To achieve the above objects, the present invention provides a method for manufacturing an epoxy nanocomposite material containing vapor-grown carbon nanofibers, the method comprising: physically mixing 0.1-5.0 parts by weight of vapor-grown carbon nanofibers as reinforcing materials with 100 parts by weight of an epoxy matrix resin to disperse the carbon nanofibers in the epoxy matrix resin; adding a curing agent to the dispersed mixture; and curing the mixture in a temperature range of 70-200° C. for 150-210 minutes at a temperature elevation rate of 5° C./min.

The vapor-grown carbon nanofibers have a mean diameter of 80-220 nm, a length of 5-25 μm and a tensile strength of 0.1-3.5 GPa.

In the inventive method, the curing agent is preferably added to the mixture at an equivalent ratio of about 1:1. Also, the curing of the mixture preferably consists of a first curing step of 20-30 minutes at 70-100° C., a second curing step of 90-120 minutes at 140-160° C., and a third curing step of 40-60 minutes at 180-200° C., said curing steps comprising elevating the temperature of the mixture at a rate of 5° C./min.

In another aspect, the present invention provides an epoxy nanocomposite material containing vapor-grown carbon nanofibers, produced using said production method.

The nanocomposite material of the present invention shows a glass transition temperature of 110-160° C., and the thermal expansion coefficient of the nanocomposite material is 60-80 μm/m° C. at a temperature below the glass transition temperature, and 180-215 μm/m° C. at a temperature above the glass transition temperature.

Also, the nanocomposite material has an impact strength of 50-130 kgf·cm/cm and an interlaminar fracture toughness of 2-10 MPa·m^{1/2}.

The inventive nanocomposite material has, at room temperature in lubrication-free conditions, a frictional force of 0.3-1.1 N, a frictional coefficient of 0.05-0.30 μ, and a wear loss of 0.1-0.3 mm.

### Advantageous Effects

According to the present invention, an epoxy nanocomposite material of the present invention is produced by physically mixing vapor-grown carbon nanofibers with an epoxy matrix resin without using any solvent. Thus, the epoxy nanocomposite material can be achieved through excellent dispersion of the vapor-grown carbon nanofibers in the matrix resin compared to the case of using a solvent. Thus, it is possible to produce an epoxy nanocomposite material having excellent mechanical strength and low friction/wear properties at room temperature and excellent thermal properties even at high temperature. Also, the vapor-grown carbon nanofibers used in the present invention are cost-effective and, at the same time, used in an amount smaller than the amount of carbon nanotubes used to improve the physical properties of epoxy resin in the prior art, thus effectively reducing the production cost of the epoxy nanocomposite material.

### DESCRIPTION OF DRAWINGS

FIG. 1 is a graphic diagram showing the thermal expansion coefficient of a nanocomposite material of the present invention as a function of the content of vapor-grown carbon nanofibers.

FIG. 2 is a graphic diagram showing the impact strength of a nanocomposite material of the present invention as a function of the content of vapor-grown carbon nanofibers.

FIG. 3 is a graphic diagram showing the interlaminar fracture strength of a nanocomposite material of the present invention as a function of the content of vapor-grown carbon nanofibers.

FIG. 4 is a graphic diagram showing the friction force of a nanocomposite material of the present invention as a function of the content of vapor-grown carbon nanofibers.

FIG. 5 is a graphic diagram showing the frictional coefficient of a nanocomposite material of the present invention as a function of the content of vapor-grown carbon nanofibers.

FIG. 6 is a graphic diagram showing the wear loss of a nanocomposite material of the present invention as a function of the content of vapor-grown carbon nanofibers.

### BEST MODE

Hereinafter, the present invention will be described in detail.

The present invention provides a method for producing an epoxy nanocomposite material containing vapor-grown carbon nanofibers, the method comprising: physically mixing 0.1-5.0 parts by weight of vapor-grown carbon nanofibers as reinforcing materials with 100 parts by weight of an epoxy matrix resin to disperse the carbon nanofibers in the matrix resin; adding a curing agent to the dispersed mixture; and curing the mixture in a temperature range of 70-200° C. for 150-210 minutes at a temperature elevation rate of 5° C./min.

According to the present invention, an epoxy nanocomposite material of the present invention is produced by physically mixing vapor-grown carbon nanofibers with an epoxy matrix resin without using any solvent. Thus, the epoxy nanocomposite material can be achieved through excellent dispersion of the vapor-grown carbon nanofibers in the matrix resin compared to the case of using a solvent. Thus, it is possible to produce an epoxy nanocomposite material having excellent mechanical strength and low friction/wear properties at room temperature and excellent thermal properties even at high temperature.

The epoxy resin is excellent in electrical properties, adhesion, tensile strength, elastic modulus, mechanical strength, thermal resistance and chemical resistance. Thus, these epoxy resin has excellent thermal properties even at high temperatures, suggesting that the loss of the physical properties thereof, caused by heat, is low. Although the present invention is described with reference to the epoxy resin, but can also be applied to other thermosetting resins. More preferably, the present invention use an epoxy matrix resin having a highly crosslinked structure and high thermal resistance to thoroughly achieve the dispersion between the epoxy resin and the reinforcing material. Herein, the epoxy matrix resin preferably has a viscosity of 11500-13500 cps. As reinforcing materials for improving the physical properties of the epoxy resin, vapor-grown carbon nanofibers are used in the present invention. More preferably, the vapor-grown carbon nanofibers for use in the present invention have a mean diameter of 80-220 nm, a length of 5-25 μm and a tensile strength of 0.1-3.5 GPa. Other than the vapor-grown carbon nanofibers, it is possible in the present invention to use nickel powder, gold powder, copper powder, metal alloy powder, carbon powder, graphite powder, carbon black, carbon fiber and the like.

The vapor-grown carbon nanofibers are used in an amount of 0.1-5.0 parts by weight based on 100 parts by weight of the epoxy matrix resin. If the vapor-grown carbon nanofibers are used in an amount of less than 0.1 parts by weight, the effect of improving the physical properties of the epoxy resin will be insignificant. On the other hand, if the nanofibers are used in an amount of more than 5.0 parts by weight, it is uneconomic because of insufficient dispersion in the epoxy matrix resin, and thus increasing the mechanical properties and wear loss of the resulting nanocomposite material.

In the process of adding the reinforcing materials to the epoxy matrix resin in the present invention, the reinforcing materials can be heated to about 80° C. with stirring for uniform dispersion. If the viscosity of the epoxy matrix resin is high, it will be difficult to completely mix the matrix resin with the reinforcing materials and to uniformly disperse the reinforcing materials in the matrix resin, thus deteriorating the mechanical properties of the resulting nanocomposite material.

In the inventive method of producing the nanocomposite material, after the vapor-grown carbon nanofibers as reinforcing materials are physically mixed with the epoxy matrix resin, a curing agent is added to the mixture, followed by curing the mixture, thus producing an epoxy nanocomposite material. Preferably, the curing of the mixture preferably consists of a first curing step of 20-30 min at 70-100° C., a second curing step of 90-120 min at 140-160° C. and a third curing-step of 40-60 min at 180-200° C., said curing steps comprising elevating the temperature of the mixture at a rate of 5° C./min. Specifically, the curing process is carried out in curing conditions set based on the glass transition temperature (40° C.) of the reaction material, at which the curing of the epoxy-containing mixture does not occur, and the highest glass transition temperature (180° C.) which is shown in a mixture system in which the epoxy was completely cured. The curing in this temperature range is advantageous in processing and economical terms compared to other temperature ranges.

As the curing agent, a conventional aromatic amine curing agent is preferably used, and examples thereof include a typical general-purpose epoxy resin, bisphenol A diglycidylether (DGEBA) having epoxy groups at both ends and an aromatic amine curing agents such as diaminodiphenyl methane (DDM) and diaminodiphenyl sulphone (DDS), which is mixed with, at an equivalent ratio of about 1:1 and cured. More preferably, diaminodiphenyl methane (DDM) is used.

Also, when the process of adding the curing agent to the mixture obtained by physically mixing the vapor-grown carbon nanofibers with the epoxy matrix resin is carried out at a temperature higher than the melting temperature of the mixture, rapid curing of the mixture will occur, so that the production of the nanocomposite material will be difficult, because the vapor-grown carbon nanofibers as reinforcing materials will be difficult to completely dissolve and the molten mixture should be placed in a mold in a short time.

Also, the present invention provides an epoxy nanocomposite material containing vapor-grown carbon nanofibers, produced by said production method.

The nanocomposite material according to the present invention shows a glass transition temperature of 110-160° C., which increases with an increase in the vapor-grown carbon nanofiber content thereof. The thermal expansion coefficient of the nanocomposite material is 60-80 μm/m° C. at a temperature below the glass transition temperature of the nanocomposite material, and 180-215 μm/m° C. at a temperature above the glass transition temperature, and thus the thermal expansion coefficient of the nanocomposite material is decreased with an increase in the vapor-grown carbon nanofiber content thereof (see FIG. 1).

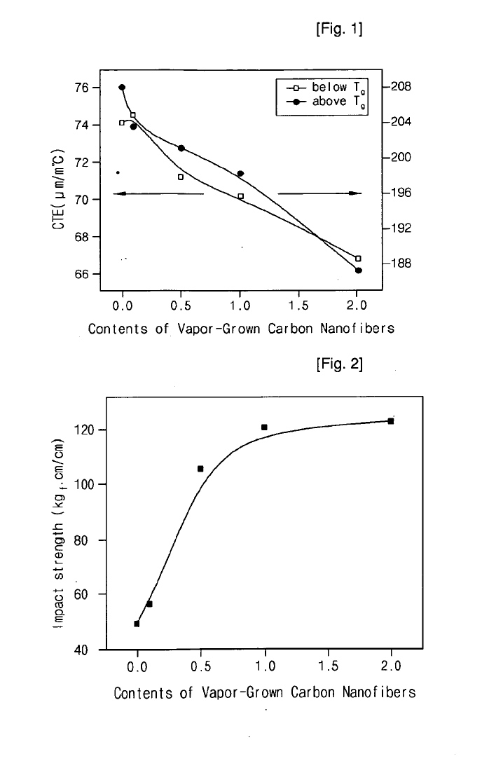

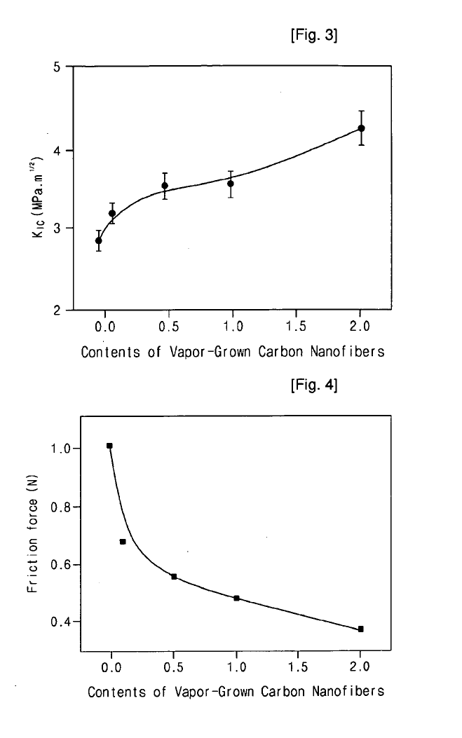

Also, the nanocomposite material of the present invention shows an increase in the impact strength and interlaminar fracture toughness thereof with an increase in the vapor-grown carbon nanofiber content thereof, and has an impact resistance of 50-130 kgf·cm/cm and an interlaminar fracture toughness of 2-10 MPa·m^{1/2} (see FIGS. 2 and 3).

The nanocomposite material of the present invention shows a remarkable decrease in the frictional force, frictional coefficient and wear loss thereof after adding the vapor-grown carbon nanofibers thereto and has, at room temperature in lubrication-free conditions, a frictional force of 0.3-1.1 N, a frictional coefficient of 0.05-0.30 μ and a wear loss of 0.1-0.3 mm, which decrease with an increase in the vapor-grown carbon nanofiber content thereof (see FIGS. 4 to 6).

### Mode for Invention

Hereinafter, the present invention will be described in further detail with reference to examples. It is to be understood, however, that these examples are illustrative only and the scope of the present invention is not limited thereto.

### Example 1

Vapor-grown carbon nanofibers (Showa Denko) having a mean diameter of 100-200 nm, a length of 10-20 μm and a tensile strength of 1-3 GPa were dried in a vacuum oven at 70° C. for 24 hours to remove the water and solvent remaining therein. Then, the dried nanofibers were physically mixed with a difunctional epoxy resin (DGEBA) (E.E.W=185-190 g/mol, density=1.16 g/cm, YD-128, Kukdo Chemical Co., Ltd.) at a weight ratio of 0.1 (nanofiber): 100 (epoxy resin). Then, diaminodiphenylmathane (DDM) as a curing agent was added to the mixture at an equivalent ratio of 1:1 and physically mixed and stirred using a mechanical mixer. Then, the mixture was cured in a curing oven for 30 minutes at 70° C., 120 minutes at 140° C. and 60 minutes at 180° C. while it was heated at a rate of 5° C./minute, thus producing an epoxy nanocomposite material containing vapor-grown carbon nanofibers.

### Example 2

An epoxy nanocomposite material containing vapor-grown carbon nanofibers was produced in the same manner as in Example 1, except that, after vapor-grown carbon nanofibers (Showa Denko) having a mean diameter of 100-200 nm, a length of 10-20 μm and a tensile strength of 1-3 GPa were dried in a vacuum oven at 70° C. for 24 hours to remove the water and solvent remaining therein, the dried nanofibers were physically mixed with a difunctional epoxy resin (DGEBA) (E.E.W=185-190 g/mol, density=1.16 g/cm, YD-128, Kukdo Chemical Co., Ltd.) at a weight ratio of 0.5 (nanofiber): 100 (epoxy resin).

### Example 3

An epoxy nanocomposite material containing vapor-grown carbon nanofibers was produced in the same manner as in Example 1, except that, after vapor-grown carbon nanofibers (Showa Denko) having a mean diameter of 100-200 nm, a length of 10-20 μm and a tensile strength of 1-3 GPa were dried in a vacuum oven at 70° C. for 24 hours to remove the water and solvent remaining therein, the dried nanofibers were physically mixed with a difunctional epoxy resin (DGEBA) (E.E.W=185-190 g/mol, density=1.16 g/cm, YD-128, Kukdo Chemical Co., Ltd.) at a weight ratio of 1 (nanofiber): 100 (epoxy resin).

### Example 4

An epoxy nanocomposite material containing vapor-grown carbon nanofibers was produced in the same manner as in Example 1, except that, after vapor-grown carbon nanofibers (Showa Denko) having a mean diameter of 100-200 nm, a length of 10-20 μm and a tensile strength of 1-3 GPa were dried in a vacuum oven at 70° C. for 24 hours to remove the water and solvent remaining therein, the dried nanofibers were physically mixed with a difunctional epoxy resin (DGEBA) (E.E.W =185-190 g/mol, density=1.16 g/cm, YD-128, Kukdo Chemical Co., Ltd.) at a weight ratio of 2 (nanofiber): 100 (epoxy resin).

### Comparative Example 1

Diaminodiphenylmathane (DDM) as a curing agent was added to a difunctional epoxy resin (DGEBA) (E.E.W=185-190 g/mol, density=1.16 g/cm, YD-128, Kukdo Chemical Co., Ltd.) at an equivalent ratio of 1:1 without adding vapor-grown carbon nanofibers and then cured, thus producing a pure epoxy composition.

### Test Example 1

### Measurement of Thermal Expansion Coefficient

The thermal expansion coefficients of the epoxy nanocomposite materials containing vapor-grown carbon nanofibers prepared in Examples 1 to 4 were measured.

Herein, the thermal expansion coefficients at temperatures below and above glass transition temperature (Tg) of each of the nanocomposites were measured using a thermomechanical analyzer (TA Instruments, Model Q400) in a nitrogen atmosphere in a temperature range of 30-300° C. at a temperature elevation rate of 10° C./min. The measurement results are shown in Table 1 below and FIG. 1.

TABLE 1
Results of measurement of glass transition temperature
according to content of vapor-grown carbon nanofibers

| Examples | Glass transition temperature (° C.) |
|---|---|
| Comparative Example 1 | 117.44 |
| Example 1 | 117.33 |
| Example 2 | 123.57 |
| Example 3 | 128.95 |
| Example 4 | 154.01 |

As can be seen in Table 1 above, the epoxy nanocomposite materials containing vapor-grown carbon nanofibers produced in Examples 1-4 showed a glass transition temperature of 110-160° C. depending on the content of the vapor-grown carbon nanofibers. Also, it is recognized that the glass transition temperature of the nanocomposite material increases with an increase in the content of the vapor-grown carbon nanofibers.

Also, as can be seen in FIG. 1, an increase in the content of the vapor-grown carbon nanofibers in the nanocomposite material led to a decrease in the thermal expansion coefficient of the nanocomposite material, the thermal expansion coefficient of the nanocomposite material was 60-80 μm/m° C. at a temperature below the glass transition temperature of the nanocomposite material, and 180-215 μm/° C. at a temperature above the glass transition temperature of the nanocomposite material. From the above results, it was thought that the carbon nanofibers reduced the flow properties of the polymer chain through interaction with the epoxy resin, and thus the increase in the content of the carbon nanofibers led to the increase in the glass transition temperature of the nanocomposite material. In addition, it was seen that, the carbon nanofibers were dispersed in the epoxy resin and absorbed heat from the internal structure of the epoxy resin, thus internal stress and crack formation in the epoxy resin is reduced and the thermal expansion coefficient of the nanocomposite material is also reduced.

### Test Example 2

### Measurement of Mechanical Properties

The impact resistance and interlaminar fracture toughness of the epoxy nanocomposite materials containing vapor-grown carbon nanofibers produced in Examples 1 to 4 were measured. For comparison, the pure epoxy composition containing no vapor-grown carbon nanofibers, produced in Comparative Example 1, was measured.

1. Measurement of Impact Strength

The impact strength of the epoxy nanocomposite materials containing vapor-grown carbon nanofibers produced in Examples 1 to 4 was measured using a drop impact tester (Model DTI-605, Dae Kyung Tech & Testers Co., Ltd.). Herein, the highest drop height was 1 m, and a load of 2 kg was used. The measurement results are shown in FIG. 2.

As can be shown in FIG. 2, the cases of Examples 1-4 containing the vapor-grown carbon nanofibers showed an increase in impact strength with an increase in the content of the vapor-grown carbon nanofibers, compared to the results of Comparative Example 1 relating to the pure epoxy composition containing no vapor-grown carbon nanofibers. Herein, the average impact strength of the epoxy nanocomposite materials containing vapor-grown carbon nanofibers produced in Examples 1 to 4 was 50-130 kgf·cm/cm.

2. Measurement of Interlaminar Fracture Toughness

The interlaminar fracture toughness (critical stress intensity factor, KIC) of the epoxy nanocomposite materials containing vapor-grown carbon nanofibers produced in Examples to 4 was measured using a single edge notch-three point bending method with a universal tester (#1125, Lloyd LR 5k, UTM) in accordance with ASTM 399. In the measurement, the notch depth of each of the samples was set to ½ of the sample thickness, the span-to-depth ratio of the samples was 4:1, and the cross-head speed of the tester was adjusted to 1 mm/min.

FIG. 3 shows the results of measurement of interlaminar fracture toughness. As shown in FIG. 3, the cases of Examples 1-4 containing the vapor-grown carbon nanofibers showed an increase in interlaminar fracture toughness with an increase in the content of the vapor-grown carbon nanofibers, compared to the results of Comparative Example 1 relating to the pure epoxy composition containing no vapor-grown carbon nanofibers. Herein, the average interlaminar fracture toughness of the epoxy nanocomposite materials containing vapor-grown carbon nanofibers produced in Examples 1 to 4 was 2-10 MPa·m^{1/2}.

### Test Example 3

### Measurement of Friction and Wear Properties

The friction and wear properties of the epoxy nanocomposite materials containing vapor-grown carbon nanofibers produced in Examples 1 to 4 were measured. For comparison, the pure epoxy composition containing no vapor-grown carbon nanofibers, produced in Comparative Example 1, was measured.

For this purpose, the friction and wear properties of the epoxy nanocomposite materials containing vapor-grown carbon nanofibers produced in Examples 1 to 4 were measured using a ball-on-disk-type tester (PD-102, R&B). Herein, each of the nanocomposite materials was prepared into a disc shape having a diameter of 30 mm and a thickness of 10 mm, and the measurement was carried out at room temperature in lubrication-free conditions after setting the speed of a frictional rotating plate to 500 rpm and applying a fixed load of 3 kg to the interface between the ball and the disc. The results of measurement of frictional force, frictional coefficient and wear loss according to the content of the vapor-grown carbon nanofibers are shown in FIGS. 4 to 6.

As shown in FIGS. 4 to 6, the epoxy nanocomposite materials containing vapor-grown carbon nanofibers produced in Examples 1-4 showed a remarkable decrease in the frictional force, frictional coefficient and wear loss. The frictional force, frictional coefficient and wear loss of the nanocomposite materials was decreased with an increase in the content of the vapor-grown carbon nanofibers.

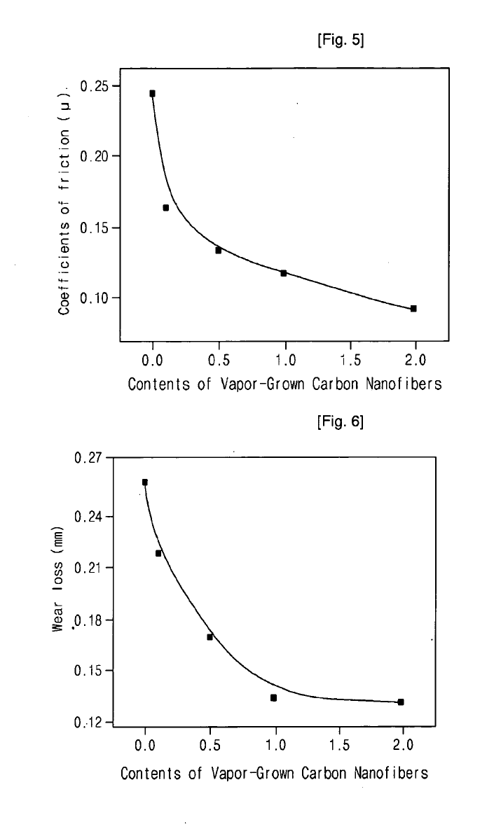

More specifically, the frictional force of the nanocomposite materials was decreased with an increase in the content of the vapor-grown carbon nanofibers, and the epoxy nanocomposite materials containing vapor-grown carbon nanofibers produced in Examples 1 to 4 had an average frictional force of 0.3-1.1 N at room temperature in lubrication-free conditions (see FIG. 4). Also, the frictional coefficient thereof was 0.05-0.30 μ (see FIG. 5).

Also, the wear loss of the epoxy nanocomposite materials containing vapor-grown carbon nanofibers produced in Examples 1 to 4 was less than 0.3 mm, particularly 0.1-0.3 mm, and was remarkably decreased with an increase in the content of with an increase in the content of the vapor-grown carbon nanofibers (see FIG. 6).

### INDUSTRIAL APPLICABILITY

As described above, the present invention provides the method for producing the epoxy nanocomposite material containing vapor-grown carbon nanofibers, which can solve the problems with the prior art including the use of a solvent, by physically mixing the vapor-grown carbon nanofibers with the epoxy matrix resin to disperse the nanofibers in the matrix resin, and then curing the mixture in optimal conditions.

Also, according to the invention production method, the epoxy nanocomposite materials having excellent mechanical properties and low frictional and wear properties can be produced using a small amount of the carbon nanofibers.

In addition, the vapor-grown carbon nanofibers, which are used in the present invention, are cost-effective and, at the same time, used in an amount smaller than that of the carbon nanofibers used to improve the physical properties of epoxy resin in the prior art. Thus, the vapor-grown carbon nanotubes contribute to a reduction in the production cost of the nanocomposite material.

Although the preferred embodiment of the present invention has been described for illustrative purposes, those skilled in the art will appreciate that various modifications, additions and substitutions are possible, without departing from the scope and spirit of the invention as disclosed in the accompanying claims.

1. A method for producing an epoxy nanocomposite material containing vapor-grown carbon nanofibers, the method comprising:
physically mixing 0.1-5.0 parts by weight of vapor-grown carbon nanofibers as reinforcing materials with 100 parts by weight of an epoxy matrix resin to disperse the carbon nanofibers in the epoxy matrix resin;
adding a curing agent to the mixture; and
curing the mixture in a temperature range of 70-200° C. for 150-210 minutes at a temperature elevation rate of 5° C./min.

2. The method according to claim 1, wherein the vapor-grown carbon nanofibers have a mean size of 80-220 nm, a length of 5-25μ and a tensile strength of 0.1-3.5 GPa.

3. The method according to claim 1, wherein the curing of the mixture consists of a first curing step of 20-30 minutes at 70-100° C., a second curing step of 90-120 minutes at 140-160° C., and a third curing step of 40-60 minutes at 180-200° C., said curing steps comprising elevating the temperature of the mixture at a rate of 5° C./min.

4. An epoxy nanocomposite material containing vapor-grown carbon nanofibers is characterized in being produced according to the method of claim 1.

5. The epoxy nanocomposite material according to claim 4, which has a glass transition temperature of 110-160° C.

6. The epoxy nanocomposite material according to claim 4, which has a thermal expansion coefficient of 60-80μ/m° C. at a temperature below the glass transition temperature of the nanocomposite material, and 180-215μ/m° C. at a temperature above the glass transition temperature of the nanocomposite material.

7. The epoxy nanocomposite material according to claim 4, which has an impact strength of 50-130 kgfμcm/cm and an interlaminar fracture toughness of 2-10 MPaμm^{1/2}.

8. The epoxy nanocomposite material according to claim 4, which has a frictional force of 0.3-1.1 N at room temperature in lubrication-free conditions.

9. The epoxy nanocomposite material according to claim 4, which has a frictional coefficient of 0.05-0.30μ at room temperature in lubrication-free conditions.

10. The epoxy nanocomposite material according to claim 4, which has a wear loss of 0.1-0.3 mm at room temperature in lubrication-free conditions.
